(19) United States
(12) Patent Application Publication
(10) Pub. No.: US 2017/0149190 A1
(43) Pub. Date: May 25, 2017

(54) OPERATING DEVICE

(71) Applicant: ALPS ELECTRIC CO., LTD., Tokyo (JP)

(72) Inventor: Katsuhiro SATO, Tokyo (JP)

(21) Appl. No.: 15/353,870

(22) Filed: Nov. 17, 2016

(30) Foreign Application Priority Data
Nov. 25, 2015 (JP) 2015-230142

(51) Int. Cl. H01R 39/64; B60R 16/023; H01R 13/26; G06F 3/0362

(52) U.S. Cl. CPC H01R 39/64; G06F 3/0362; B60R 16/023; H01R 13/26; H01R 2107/00

(57) ABSTRACT

An operating device includes: a substrate on which a plurality of electrode patterns are formed; and a sliding electrode which has three contact points sliding on the plurality of electrode patterns, which is held by an operating member that is displaced relative to the substrate according to an input operation, and whose state of connection with each of the plurality of electrode patterns at the three contact points is switched according to the displacement of the operating member. Three gaps located on three trajectories, on which the three contact points move according to the displacement of the operating member, are provided between the two adjacent electrode patterns. In a state in which any one of the contact points is located in one of the gaps, the other two or more contact points are in contact with any one of the plurality of electrode patterns.

### CLAIM OF PRIORITY

This application contains subject matter related to and claims the benefit of Japanese Patent Application No. 2015-230142 filed on Nov. 25, 2015, the entire contents of which is incorporated herein by reference.

### BACKGROUND OF THE DISCLOSURE

1. Field of the Disclosure

The present disclosure relates to an operating device applicable to the input operation of a combination switch for automobiles or various electronic apparatuses.

2. Description of the Related Art

An operating device that generates a signal corresponding to the input operation by making a sliding electrode be selectively electrically connected to one of a plurality of electrode patterns has been used in various fields. For example, in a multi-point input switching device disclosed in Japanese Unexamined Patent Application Publication No. 55-95215, a continuous-shaped common side pattern and a plurality of discontinuous-shaped switching side patterns disposed with fixed intervals therebetween are formed in parallel on the substrate. By moving a brush (slider), which slides to be brought into contact with both the common side pattern and the switching side patterns, so as to be electrically connected to any one of the plurality of switching side patterns, it is possible to perform input switching in a sequential manner.

In a conventional operating device, a gap is provided between adjacent patterns of the discontinuous-shaped switching side patterns. For this reason, when the sliding electrode moves, a state in which there is no electrical connection between patterns necessarily occurs. In order to perform a switching operation without making the sliding electrode and the switching side patterns be electrically disconnected from each other, at the time of switching from one switching side pattern to an adjacent switching side pattern, the sliding electrode needs to be stably electrically connected to both the switching side patterns.

Therefore, it is possible to consider a method of providing two contact points in the sliding electrode so that, even if one contact point is electrically disconnected from the switching side patterns when the one contact point passes through a gap, an electrical connection state is maintained by the other contact point.

However, since the sliding electrode is electrically connected to the switching side patterns while sliding, the sliding electrode may be deteriorated due to wear or the like. In a case where contact failure occurs in one of the two contact points, a state in which there is no electrical connection between the sliding electrode and the switching side patterns inevitably occurs.

These and other drawbacks exist.

### SUMMARY OF THE DISCLOSURE

The various embodiments of the disclosure provide an operating device capable of making the interruption of conduction due to contact failure of a contact point of a sliding electrode hardly occur.

An operating device according to an example embodiment includes: a substrate on which a plurality of electrode patterns are formed; and a sliding electrode which has N (N is an integer of 3 or more) contact points sliding on the plurality of electrode patterns, which is held by an operating member that is displaced relative to the substrate according to an input operation, and whose state of connection with each of the plurality of electrode patterns at the N contact points is switched according to displacement of the operating member. N gaps located on N trajectories, on which the N contact points move according to the displacement of the operating member, are provided between two adjacent electrode patterns. In a state in which any one of the contact points is located in one of the gaps, each of the other two or more contact points is in contact with any one of the plurality of electrode patterns. For example, in a state in which any one of the contact points is located in one of the gaps, the other two or more contact points are in contact with any one of the two adjacent electrode patterns.

According to this embodiment, in a state in which any one of the contact points is located in one of the gaps, the other two contact points are in contact with any one of the plurality of electrode patterns. Accordingly, even if contact failure occurs in any one of the N contact points, one or more contact points are necessarily in contact with any one of the plurality of electrode patterns. Therefore, interruption of conduction due to contact failure of the contact point of the sliding electrode can be made to hardly occur.

Also, the N contact points are aligned linearly in a predetermined direction with respect to a movement direction according to the displacement of the operating member, and a location where each of the N gaps is disposed is included in a region where the electrode patterns are formed on two or more trajectories, on which the other gaps are located, when viewed from the predetermined direction.

In this embodiment, the N contact points are aligned linearly in the predetermined direction, and the location where each of the N gaps is disposed is included in a region where the electrode patterns are formed on two or more trajectories, on which the other gaps are located, when viewed from the predetermined direction. Therefore, in a state in which any one contact point is located in one gap, the other two or more contact points are in contact with any one of the plurality of electrode patterns.

The predetermined direction is a direction perpendicular to a movement direction of each of the contact points. According to this embodiment, since the contact points are aligned perpendicular to the movement direction, the sliding electrode becomes small.

The N gaps are formed between two edge portions facing each other in the two adjacent electrode patterns, and the two edge portions extend perpendicular to a movement direction of each of the contact points. Preferably, in a state in which any one of the contact points is located between the two edge portions, each of the other two or more contact points is in contact with any one of the two adjacent electrode patterns.

According to this example, the N gaps are formed between the two edge portions extending perpendicular to the movement direction of each of the contact points. In addition, in a state in which any one of the contact points is located between the two edge portions, each of the other two or more contact points is in contact with any one of the two adjacent electrode patterns. Therefore, in a state in which any one of the contact points is located in one of the gaps, each of the other two or more contact points is in contact with any one of the plurality of electrode patterns.

Additionally, between the two adjacent electrode patterns, at least a first gap through which a first contact point passes, a second gap through which a second contact point passes, and a third gap through which a third contact point passes are provided on trajectories on which the N contact points move according to the displacement of the operating member. For example, in a case where the first contact point, the second contact point, and the third contact point move from one of the two adjacent electrode patterns to the other electrode pattern, the second contact point reaches the second gap after the first contact point passes through the first gap, the third contact point reaches the third gap after the second contact point passes through the second gap, and the first and second contact points are in contact with the other electrode pattern when the third contact point passes through the third gap.

According to this example, at least three contact points and three gaps are provided between the two adjacent electrode patterns. In addition, when a certain contact point passes through a certain gap, the other two contact points are sliding. Therefore, even if contact failure occurs in one of the contact points that are sliding, the sliding operation is performed by the other contact point.

The operating member rotates relative to the substrate according to the input operation, and the N contact points move on N trajectories, which form concentric arcs, according to the rotation of the operating member.

According to this embodiment, even in a case where the operating member rotates relative to the substrate, interruption of conduction due to contact failure of the contact points of the sliding electrode is difficult to occur.

Additionally, the N contact points are aligned in radial directions of the N trajectories that form the concentric arcs.

According to this example, since the N contact points are aligned in the radial directions, it is possible to reduce the size of the sliding electrode.

Further, edge portions of the two electrode patterns facing each other with the gap interposed therebetween are formed in parallel to a straight line, which passes through the gap and extends in the radial directions of the arc shaped trajectories.

According to this example, the edge portions of the two electrode patterns facing each other with the gap interposed therebetween are formed in parallel to the straight line that passes through the gap and extends in the radial directions. Therefore, even if there is an error in the size of the electrode pattern due to manufacturing variations or the like, it is possible to appropriately cause a state in which two or more contact points are in contact with any one of the two electrode patterns.

The operating member moves straight relative to the substrate according to the input operation, and the N contact points move on the N trajectories parallel to each other according to the straight movement of the operating member.

In this example, even in a case where the operating member moves straight relative to the substrate, interruption of conduction due to contact failure of the contact point of the sliding electrode is difficult to occur.

A common electrode pattern is further formed on the substrate, and the sliding electrode has at least one common contact point sliding on the common electrode pattern according to the displacement of the operating member. The common contact point is always in contact with the common electrode pattern while a state of connection with each of the plurality of electrode patterns at the N contact points is being switched according to the displacement of the operating member.

According to this embodiment, the common contact point is always in contact with the common electrode pattern while a state of connection with each of the plurality of electrode patterns at the N contact points is being switched according to the displacement of the operating member. Therefore, a state of electrical connection between the common electrode pattern and the plurality of electrodes is switched according to the displacement of the operating member.

In various embodiments, the operating device further includes: a resistance circuit which has a plurality of electrode nodes, which are connected to the plurality of electrode patterns, and a measurement node and whose resistance value between the measurement node and the common electrode pattern changes when the state of connection with each of the plurality of electrode patterns at the N contact points is switched according to the displacement of the operating member; and a signal generating circuit that generates a signal corresponding to a resistance value between the measurement node and the common electrode pattern.

M (M is an integer of 2 or more) electrode patterns aligned along trajectories, on which the contact points move, are further provided, and the resistance circuit includes a first resistor, which is provided between two adjacent electrode patterns of the M electrode patterns, and a second resistor provided between an electrode pattern, which is located at one end of the M electrode patterns, and the measurement node.

### BRIEF DESCRIPTION OF THE DRAWINGS

FIG. 1 is a perspective view showing the appearance of a stalk switch in which an operating device according to an example embodiment is mounted;

FIG. 2 is an exploded enlarged perspective view showing a state after removing a main part and a rotary member of the operating device according to an example embodiment;

FIG. 3 is a diagram showing a plurality of electrode patterns formed on a substrate according to an example embodiment;

FIG. 4 is a diagram showing the arrangement state of a sliding electrode on the substrate according to an example embodiment;

FIG. 5 is a diagram for explaining a gap provided between a plurality of electrode patterns according to an example embodiment;

FIGS. 6A and 6B are diagrams showing the appearance of a sliding electrode, where FIG. 6A shows the appearance of the sliding electrode when viewed from a direction perpendicular to the surface of the substrate and FIG. 6B shows the appearance of the sliding electrode when viewed from a direction parallel to the surface of the substrate;

FIG. 7 is a diagram showing an example of the arrangement of contact points according to an example embodiment;

FIG. 8 is a diagram showing an example of the configuration of a circuit that generates a signal corresponding to the connection state between the sliding electrode and a plurality of electrode patterns;

FIG. 9 is a diagram for explaining a first modification example, and shows straight lines extending radially with respect to the rotation center;

FIGS. 10A and 10B are diagrams for explaining the first modification example and are enlarged views of a gap on the inner circumferential side between electrode patterns, where FIG. 10A shows a case where edge portions extend radially and FIG. 10B shows a case where edge portions extend in parallel with the centerline of the gap;

FIGS. 11A and 11B are diagrams for explaining the first modification example and are enlarged views of a gap on the outer circumferential side between electrode patterns, where FIG. 11A shows a case where edge portions extend radially and FIG. 11B shows a case where edge portions extend in parallel with the centerline of the gap;

FIG. 12 is a first diagram showing a modification example of the shape of a gap in a case where contact points are aligned linearly;

FIG. 13 is a second diagram showing a modification example of the shape of a gap in a case where contact points are aligned linearly;

FIG. 14 is a third diagram showing a modification example of the shape of a gap in a case where contact points are aligned linearly;

FIG. 15 is a diagram showing a modification example of an electrode pattern in which a plurality of gaps, through which respective contact points pass, are formed between two edge portions extending linearly;

FIG. 16 is a first diagram showing an example of a sliding electrode applicable to the electrode pattern shown in FIG. 15;

FIG. 17 is a second diagram showing an example of a sliding electrode applicable to the electrode pattern shown in FIG. 15;

FIG. 18 is a third diagram showing an example of a sliding electrode applicable to the electrode pattern shown in FIG. 15;

FIG. 19 is a first diagram showing an example of the electrode pattern in a case where a plurality of contact points of the sliding electrode move on parallel trajectories; and

FIG. 20 is a first diagram showing an example of the electrode pattern in a case where a plurality of contact points of the sliding electrode move on parallel trajectories.

### DETAILED DESCRIPTION OF THE DISCLOSURE

Hereinafter, an operating device according to the various example embodiments is described. The following description is intended to convey a thorough understanding of the embodiments described by providing a number of specific embodiments and details involving an operating device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

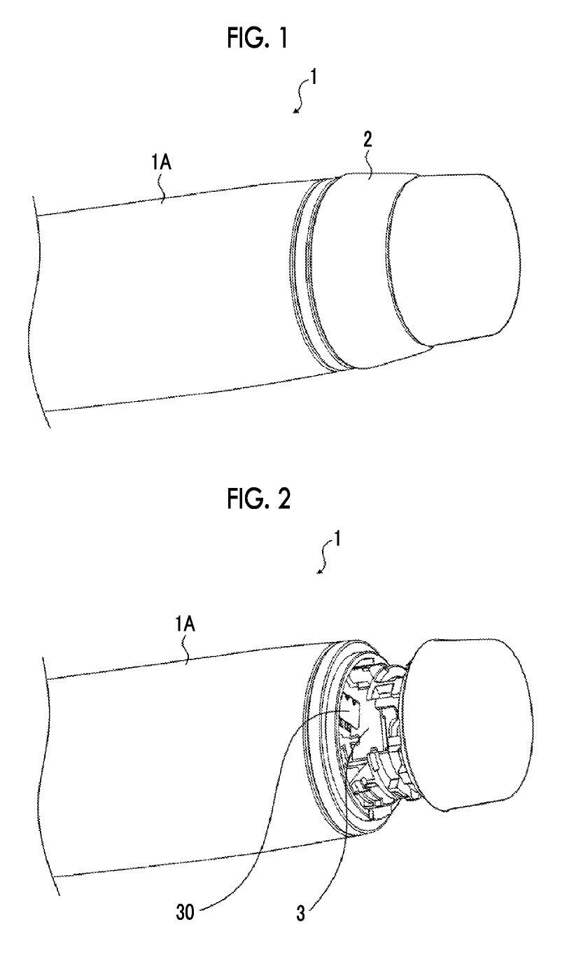

FIG. 1 is a perspective view showing the appearance of a stalk switch 1 in which the operating device according to an example embodiment is mounted. FIG. 2 shows a main part (a substrate 3 and a sliding electrode 30) of the operating device disposed in the stalk switch 1, and is an exploded enlarged perspective view showing a state after removing an operating member (rotary operating knob) 2.

The stalk switch 1 may be an input device disposed in the vicinity of the steering wheel of a car or the like. The stalk switch 1 may have a switch portion (not shown) that generates a control signal of a direction indictor, a windshield wiper, or the like according to the tilting operation of a rod-shaped stalk switch body 1A, and may have an operating device provided in the vicinity of the distal end of the stalk switch body 1A. The operating device generates a control signal of a headlight or a parking light according to the rotational input operation of the operating member 2. The operating device may have a small diameter to such an extent that the driver of the automobile can pinch the operating device with fingers to perform a rotation operation, and components of the operating device are also small.

As shown in FIG. 2, the operating member 2, which may be rotatably mounted in the stalk switch body 1A, and the substrate 3 of the operating device may be provided on the distal end side of the stalk switch body 1A. The operating member 2 may rotate relative to the substrate 3 according to the rotational input operation. The sliding electrode 30, which will be described later, may be held by the operating member 2.

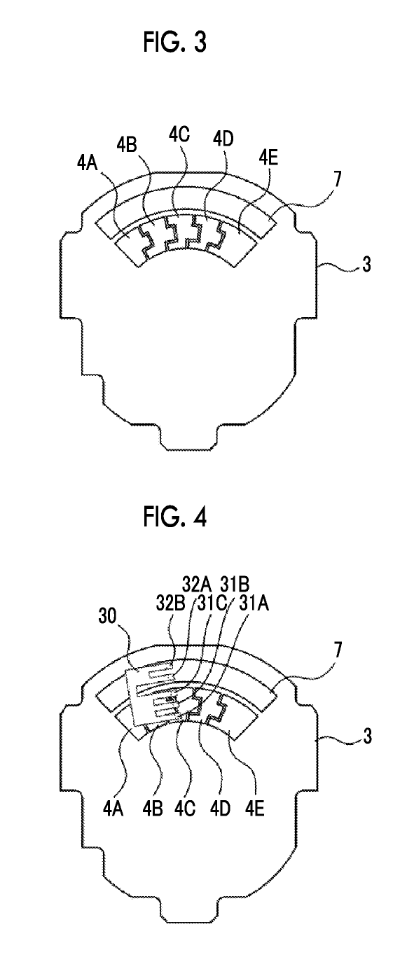

FIG. 3 is a diagram showing electrode patterns 4A to 4E and 7 formed on the substrate 3. FIG. 4 is a diagram showing the arrangement state of the sliding electrode 30 on the substrate 3. As shown in FIGS. 3 and 4, the five electrode patterns 4A to 4E whose state of contact with the sliding electrode 30 is switched according to the rotation of the operating member 2 and a common electrode pattern 7, which is always in contact with the sliding electrode 30, may be formed on the substrate 3. In the following explanation, the electrode patterns 4A to 4E may be referred to as an “electrode pattern 4” without distinction. Although a case where the number of electrode patterns 4 is four will be described as an example herein, the number of electrode patterns 4 may be any number of two or more without being limited thereto.

The sliding electrode 30 may have three contact points 31A to 31C sliding on the electrode patterns 4A to 4E and two common contact points 31D and 31E sliding on the common electrode pattern 7. In the following explanation, the contact points 31A to 31C may be referred to as a “contact point 31” without distinction, and the common contact points 32A and 32B may be referred to as a “common contact point 32” without distinction. Although a case where the number of contact points 31 is three will be described as an example herein, the number of contact points 31 may be four or more without being limited thereto. In addition, the number of common contact points 32 may be any number other than two.

The electrode patterns 4A to 4E may be formed side by side along trajectories on which the contact points 31A to 31C of the sliding electrode 30 move with the rotation of the operating member 2. Since the trajectories on which the contact points 31A to 31C move form concentric arcs, the electrode patterns 4A to 4E also may be formed side by side along the concentric arc shaped trajectories.

The common electrode pattern 7 may be formed on the trajectories on which the common contact points 32A and 32B of the sliding electrode 30 move with the rotation of the operating member 2. Since the trajectories on which the contact points 32A and 32B move form concentric arcs in the same manner as in the case of the contact points 31A to 31C, the common electrode pattern 7 also may be formed on the concentric arc shaped trajectories. Compared with the electrode patterns 4A to 4E, the common electrode pattern 7 is located on a side (outer diameter side) farther from the center of the concentric arcs.

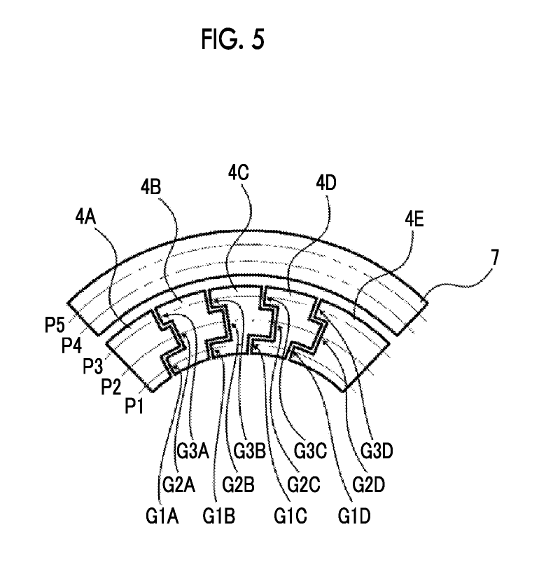

FIG. 5 is a diagram for explaining a gap provided between the electrode patterns 4A to 4E. “P1” to “P5” in FIG. 5 indicate trajectories on which the contact points 31A to 31C and the common contact points 32A and 32B move with the rotation of the operating member 2. That is, “P1” indicates the trajectory of the contact point 31A, “P2” indicates the trajectory of the contact point 31B, “P3” indicates the trajectory of the contact point 31C, “P4” indicates the trajectory of the contact point 32A, and “P5” indicates the trajectory of the contact point 32B. The trajectories P1 to P5 extend in a concentric arc shape. The radius of the arc of the trajectory P1 is the shortest, and the radius of the arc increases in the order of the trajectories P1, P2, P3, P4, and P5. In the following explanation, the trajectories P1 to P5 may be referred to as a “trajectory P” without distinction.

“G1A” to “G3A”, and “G1B” to “G3B”, “G1C” to “G3C” and “G1D” to “G3D” in FIG. 5 indicate a gap between two electrode patterns located on the trajectories P1 to P5.

“G1A” to “G3A” indicate a gap between the electrode patterns 4A and 4B. The gap G1A may be located on the trajectory P1, the gap G2A may be located on the trajectory P2, and the gap G3A may be located on the trajectory P3.

“G1B” to “G3B” indicate a gap between the electrode patterns 4B and 4C. The gap G1B may be located on the trajectory P1, the gap G2B may be located on the trajectory P2, and the gap G3B may be located on the trajectory P3.

“G1C” to “G3C” indicate a gap between the electrode patterns 4C and 4D. The gap G1C may be located on the trajectory P1, the gap G2C may be located on the trajectory P2, and the gap G3C may be located on the trajectory P3.

“G1D” to “G3D” indicate a gap between the electrode patterns 4D and 4E. The gap G1D may be located on the trajectory P1, the gap G2D may be located on the trajectory P2, and the gap G3D may be located on the trajectory P3.

In the following explanation, any one of the gaps G1A to G3A, the gaps G1B to G3B, the gaps G1C to G3C, and the gaps G1D to G3D may be referred to as a “gap G”. In addition, three gaps located between the two adjacent electrode patterns 4 may be referred to as “gaps G1 to G3”. The gap G1 may be located on the trajectory P1, the gap G2 is located on the trajectory P2, and the gap G3 is located on the trajectory P3.

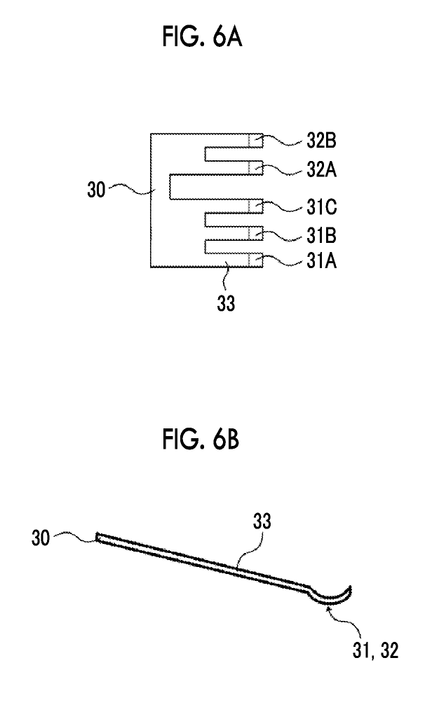

FIGS. 6A and 6B are diagrams showing the appearance of the sliding electrode 30. FIG. 6A shows the appearance of the sliding electrode 30 when viewed from a direction perpendicular to the surface of the substrate 3, and FIG. 6B shows the appearance of the sliding electrode 30 when viewed from a direction parallel to the surface of the substrate 3. As shown in FIGS. 6A and 6B, the sliding electrode 30 is formed in the shape of a thin plate spring as a whole. The sliding electrode 30 has five arm portions 33 extending in parallel to each other. The five arm portions 33 can be elastically deformed separately from each other, and each distal end has a rounded shape toward the surface of the substrate 3. The distal ends of the arm portions 33 may be in contact with the electrode patterns 4A to 4E and 7 of the substrate 3 as the contact points 31A to 31C, 32A, and 32B, respectively.

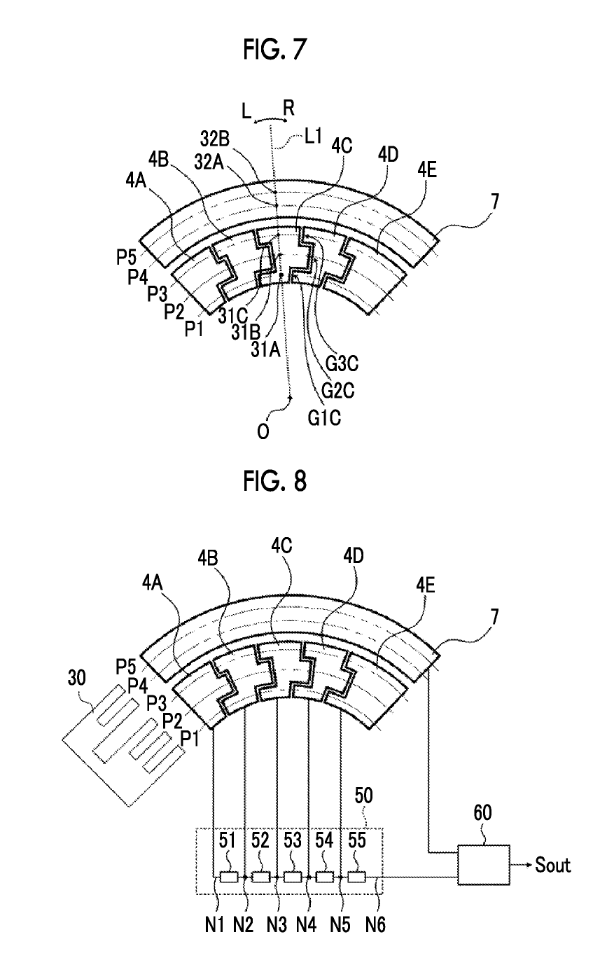

FIG. 7 is a diagram showing an example of the arrangement of the contact points 31A to 31C, 32A, and 32B. “O” in FIG. 7 indicates the rotation center of the trajectories P1 to P5 of the contact points 31A to 31C, 32A, and 32B that move with the rotation of the operating member 2. In addition, “L1” indicates a virtual straight line extending in the radial direction from the rotation center O. In the example shown in FIG. 7, the contact points 31A to 31C, 32A, and 32B may be aligned linearly in a direction along the virtual straight line L (radial direction of the trajectories P1 to P5 that form concentric arcs).

In the example shown in FIG. 7, the movement direction of the contact points 31A to 31C may be a direction along the arc shaped trajectories P1 to P3. Therefore, the arrangement direction of the contact points 31A to 31C may be a direction perpendicular to the movement direction of the contact points 31A to 31C (tangential direction of the arc). Thus, the contact points 31A to 31C may be aligned linearly in a predetermined direction with respect to the movement direction of the contact points 31A to 31C according to the rotation of the operating member 2 (in the example shown in FIG. 7, in the radial direction with respect to the rotation center O).

In such an embodiment, the arrangement of each gap G on the trajectories P1 to P3 and the arrangement direction of the contact points 31A to 31C may be determined so that each of the other two contact points is in contact with any one of the electrode patterns 4A to 4E in a state in which any one of the three contact points 31A to 31C is located in one gap G.

As shown in FIG. 7, in a case where the contact points 31A to 31C are aligned linearly in a predetermined direction (in the example shown in FIG. 7, in the radial direction with respect to the rotation center O), a location where each of the three gaps G1 to G3 is disposed may be included in a region where the electrode pattern 4 is formed on two trajectories, on which the other two gaps are located, when viewed from the predetermined direction. That is, a location where a gap is disposed on the one trajectory P is included in a region where the gap G is not present on the other two trajectories P, when viewed from the predetermined direction (in the example shown in FIG. 7, in the radial direction with respect to the rotation center O).

For example, a location where the gap G1 of the three gaps G1 to G3 is disposed may be included in a region where the electrode pattern 4 is formed on the trajectories P2 and P3, on which the other gaps G2 and G3 are located, when viewed from a direction in which the contact points 31A to 31C are aligned linearly (radial direction with respect to the rotation center O). In other words, a location where the gap G1 is disposed on the trajectory P1 may be included in a region where the gap G is not present on the other two trajectories P2 and P3, when viewed from a direction in which the contact points 31A to 31C are aligned linearly (radial direction with respect to the rotation center O).

For example, in a case where the contact points 31A to 31C are the positions shown in FIG. 7, the sliding electrode 30 may be assumed to rotate (be displaced) in the direction of “R”. In this case, the contact points 31A to 31C move to the electrode pattern 4D from the electrode pattern 4C. First, the contact point 31A passes through the gap G1C, and then the contact point 31C reaches the gap G3C. After the contact point 31C passes through the gap G3C, the contact point 31B reaches the gap G2C. When the contact point 31B passes through the gap G2C, the contact points 31A and 31C are in contact with the electrode pattern 4D. Therefore, in a case where the contact points 31A to 31C move to the electrode pattern 4D from the electrode pattern 4C, at least two of the contact points 31A to 31C are in contact with any of the electrode patterns 4C and 4D. Even if contact failure occurs between the electrode pattern 4 and any one of the contact points 31A to 31C, one contact point is necessarily in contact with any electrode pattern 4. Accordingly, the sliding electrode 30 and the electrode pattern 4 are always electrically connected to each other.

In addition, the common contact points 32A and 32B are always in contact with the common electrode pattern 7 while the state of connection with each of the plurality of electrode patterns 4 at the contact points 31A to 31C is being switched according to the rotation of the operating member 2. Even if contact failure occurs between the common electrode pattern 7 and any one of the contact points 31A to 31C, one contact point is necessarily in contact with the common electrode pattern 7. Accordingly, the sliding electrode 30 and the common electrode pattern 7 are always electrically connected to each other.

FIG. 8 is a diagram showing an example of the configuration of a circuit that generates a signal corresponding to the connection state between the sliding electrode 30 and a plurality of electrode patterns 4. The operating device shown in the example of FIG. 8 has a resistance circuit 50 and a signal generating circuit 60.

The resistance circuit 50 has five electrode nodes N1 to N5 connected to the five electrode patterns 4A to 4E, respectively, and a measurement node N6. The electrode node N1 may be connected to the electrode pattern 4A, the electrode node N2 may be connected to the electrode pattern 4B, the electrode node N3 may be connected to the electrode pattern 4C, the electrode node N4 may be connected to the electrode pattern 4D, and the electrode node N5 may be connected to the electrode pattern 4E. In the resistance circuit 50, when the state of connection with each of the electrode patterns 4A to 4E at the contact points 31A to 31C may be switched according to the displacement of the operating member 2, a resistance value between the measurement node N6 and the common electrode pattern 7 (hereinafter, may be referred to as a “measurement resistance value”) changes.

In the example shown in FIG. 8, the resistance circuit 50 may have first resistors 51 to 54 and a second resistor 55. Each of the first resistors 51 to 54 may be provided between two adjacent electrode patterns 4. That is, the first resistor 51 may be connected between the electrode nodes N1 and N2, the first resistor 52 may be connected between the electrode nodes N2 and N3, the first resistor 53 may be connected between the electrode nodes N3 and N4, and the first resistor 54 may be connected between the electrode nodes N4 and N5. The second resistor 55 may be provided between the measurement node N6 and the electrode pattern 4E at one end of the four electrode patterns 4 aligned along the arc shaped trajectories P1 to P4.

The measurement resistance value between the measurement node N6 and the common electrode pattern 7 changes according to the number of resistors that are connected in series between the measurement node N6 and the common electrode pattern 7 through the sliding electrode 30. In a case where the contact points 31A to 31C are in contact with the electrode pattern 4E, only the second resistor 55 is a resistor connected in series. Accordingly, the measurement resistance value becomes the smallest. When the contact targets of the contact points 31A to 31C are switched in order of the electrode patterns 4E, 4D, 4C, 4B, and 4A, the number of resistors connected in series is increased. Accordingly, the measurement resistance value increases. In a case where the contact points 31A to 31C are in contact with the electrode pattern 4A, the first resistors 51 to 54 and the second resistor 55 are all connected in series. Accordingly, the measurement resistance value becomes the maximum.

The signal generating circuit 60 generates a signal Sout corresponding to the measurement resistance value between the measurement node N6 and the common electrode pattern 7. For example, the signal generating circuit 60 generates the signal Sout, which indicates a connection state between the sliding electrode 30 and the electrode patterns 4A to 4E, based on a current flowing when a fixed voltage is applied between the measurement node N6 and the common electrode pattern 7 or a voltage generated when a fixed current flows between the measurement node N6 and the common electrode pattern 7.

As described above, according an example operating device, in a state in which any one contact point 31 is located in one gap G, each of the other two contact points 31 is in contact with any one of the plurality of electrode patterns 4. Accordingly, even if contact failure occurs in any one of the three contact points 31, one contact point 31 is necessarily in contact with any one of the plurality of electrode patterns 4. Therefore, interruption of conduction due to contact failure of the contact point 31 of the sliding electrode 30 can be made to hardly occur.

In addition, according to an example operating device, the three contact points 31 are aligned linearly in a predetermined direction with respect to the movement direction of each contact point 31, and the location where each of the three gaps G1 to G3 located between the two adjacent electrode patterns 4 is disposed is included in a region where the electrode pattern 4 is formed on two trajectories, on which the other two gaps are located, when viewed from the predetermined direction. For this reason, in a state in which any one contact point is located in one gap, the other two or more contact points may be in contact with any one of the plurality of electrode patterns 4. Thus, since the other two contact points 31 may be in contact with any one of the plurality of electrode patterns 4 in a state in which any one contact point 31 is located in one gap G, interruption of conduction due to contact failure of the contact point 31 of the sliding electrode 30 can be made to hardly occur.

In addition, according to an example operating device, since the three contact points 31 are aligned linearly in a direction perpendicular to the movement direction of each contact point 31 (radial direction of the trajectories P that form concentric arcs), it is possible to reduce the size of the sliding electrode 30. In particular, it is possible to further reduce the size of the sliding electrode 30 by aligning a plurality of contact points including the common contact point 32 on the same straight line.

Next, some additional examples of the various operating devices disclosed will be described.

A first example relates to edge portions of the two electrode patterns 4 that form the gap G. Although the gaps G1B and G3B between the electrode patterns 4B and 4C will be described as an example below, edge portions of the other gaps can also be made to have the same shape.

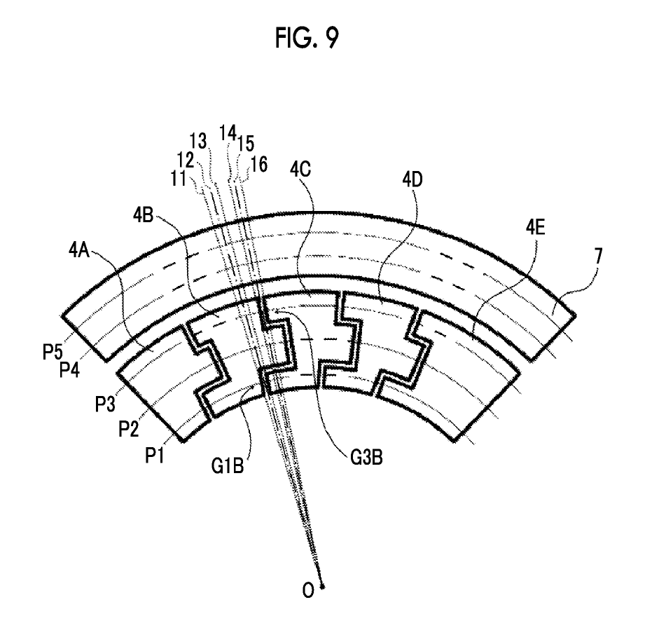

FIGS. 9 to 11 are diagrams for explaining the first example. FIG. 9 shows straight lines 11 to 16 extending radially with respect to the rotation center O of the sliding electrode 30. The straight line 12 passes through the center of the gap G1B, and the straight lines 11 and 13 pass through the vicinity of both ends of the gap G1B. The straight line 15 passes through the center of the gap G3B, and the straight lines 14 and 16 pass through the vicinity of both ends of the gap G3B.

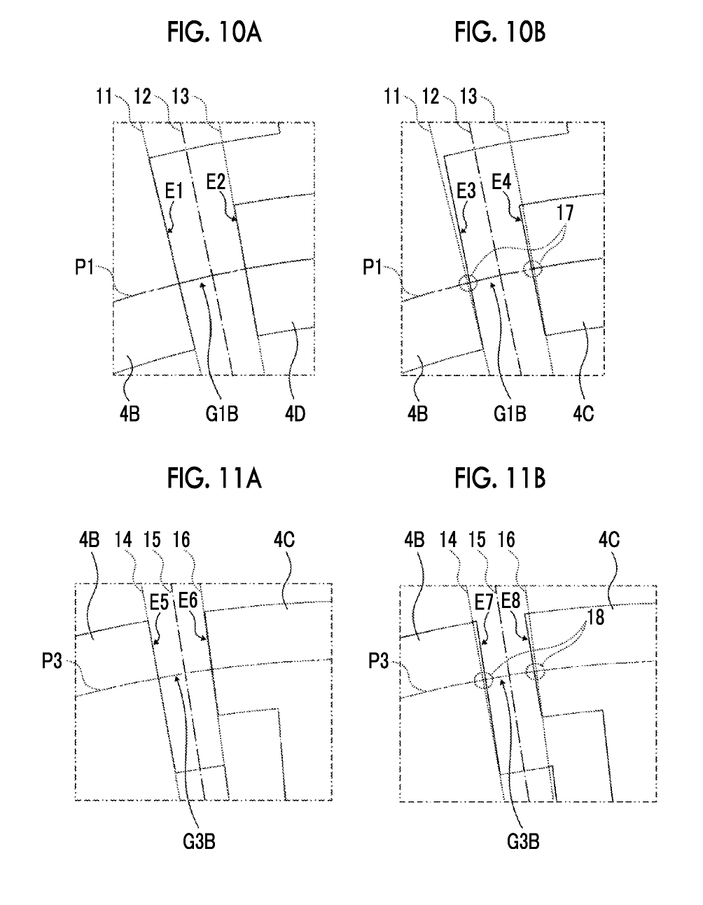

FIGS. 10A and 10B are enlarged views of the gap G1B on the inner circumferential side between the electrode patterns 4B and 4C. FIG. 10A shows a case where edge portions E1 and E2 extend radially, and FIG. 10B shows a case where the edge portions E3 and E4 extend in parallel with a centerline 12 of the gap.

FIGS. 11A and 11B are enlarged views of the gap G3B on the outer circumferential side between the electrode patterns 4B and 4C. FIG. 11A shows a case where edge portions E5 and E6 extend radially, and FIG. 11B shows a case where the edge portions E7 and E8 extend in parallel with a centerline 15 of the gap.

The contact points 31A to 31C move on the concentric arc shaped trajectories P1 to P3. In general, therefore, it is considered that the edge portions of the two electrode patterns 4 forming one gap G are formed in a shape extending in a direction perpendicular to the movement direction of the contact points 31A to 31C, that is, a shape extending radially with respect to the rotation center O. FIGS. 10A and 11A show the example. In FIG. 10A, each of the edge portions E1 and E2 of the electrode patterns 4B and 4C that form the gap G1B extends radially. In FIG. 11A, each of the edge portions E5 and E6 of the electrode patterns 4B and 4C that form the gap G3B extends radially.

The positions of the edge portions E1 and E2 shown in FIG. 10A or the positions of the edge portions E5 and E6 shown in FIG. 11A are defined by the angles of straight lines 11, 13, 14, and 16 extending radially from the rotation center O. Therefore, particularly in the edge portions E1 and E2 on the inner circumferential side, the accuracy of the position is strict. The accuracy of the position of each edge portion may be affected by manufacturing variations in etching the pattern of a conductor on the substrate 3, for example. In order to ensure that a non-conduction state between the sliding electrode 30 and the electrode pattern 4 does not occur, it is necessary to provide a margin in the position of the edge portion in consideration of the error of the position of the edge portion that may occur due to manufacturing variations or the like. However, if the angle of each of the straight lines 11, 13, 14, and 16 of the edge portions is rotated too much in order to provide a margin, a connection switching point between the sliding electrode 30 and the electrode pattern 4 is likely to be shifted from the desired angle.

Therefore, in the first example shown in FIGS. 10B and 11B, edge portions of the two electrode patterns 4 facing each other with a gap interposed therebetween are formed in parallel to the straight line, which passes through the gap and extends radially with respect to the rotation center O. That is, in FIG. 10B, the edge portions E3 and E4 of the two electrode patterns 4B and 4C facing each other with the gap G1B interposed therebetween may be formed in parallel to the straight line 12, which passes through the center of the gap G1B and extends radially. In FIG. 11B, the edge portions E7 and E8 of the two electrode patterns 4B and 4C facing each other with the gap G3B interposed therebetween are formed in parallel to the straight line 15, which passes through the center of the gap G3B and extends radially.

The gap between two straight lines (gap between the straight lines 11 and 13 and the gap between the straight lines 14 and 16) that extend radially becomes wider toward the outer circumferential side from the inner circumferential side. On the other hand, since the edge portions E3 and E4 may be parallel to each other and the edge portions E7 and E8 are parallel to each other, the gap on the inner circumferential side and the gap on the outer circumferential side are the same. Accordingly, a margin region that narrows the gap G1B as shown by a dotted circle 17 in FIG. 10B is generated between the edge portion E3 and the straight line 11 and between the edge portion E4 and the straight line 13, and a margin region that narrows the gap G3B as shown by a dotted circle 18 in FIG. 11B is generated between the edge portion E7 and the straight line 14 and between the edge portion E8 and the straight line 16. Therefore, even if an error occurs in the size of the electrode pattern 4 by the influence of manufacturing variations of the substrate 3, a non-conduction state between the sliding electrode 30 and the electrode pattern 4 can be made to hardly occur. In addition, since the edge portions of the two electrode patterns 4 facing each other with a gap interposed therebetween are formed in parallel to each other, it is possible to appropriately set a margin for preventing the non-conduction between the sliding electrode 30 and the electrode pattern 4 compared with a case of adjusting the angle of each edge portion extending radially. Therefore, it becomes easy to set the connection switching point between the sliding electrode 30 and the electrode pattern 4 to a desired angle.

### Second Modification Example

In the example described above, in the case of rotating the sliding electrode 30 in the R direction (FIG. 7) from the one electrode pattern 4 to the adjacent electrode pattern 4, the contact point 31A passes through the gap G1 of the trajectory P1 first, then the contact point 31C passes through the gap G3 of the trajectory P3, and finally the contact point 31B passes through the gap G2 of the trajectory P2. However, the order in which the contact points 31A to 31C pass through the gaps is not limited to this example. That is, the order in which the contact points 31A to 31C pass through the gaps is arbitrary as long as each of the other two contact points is in contact with any one of the electrode patterns 4A to 4E in a state in which any one of the three contact points 31A to 31C is located in one gap G.

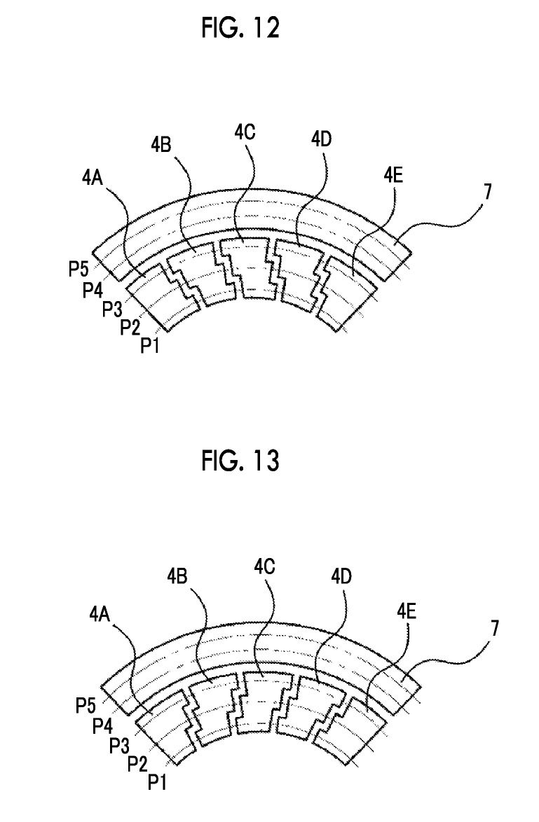

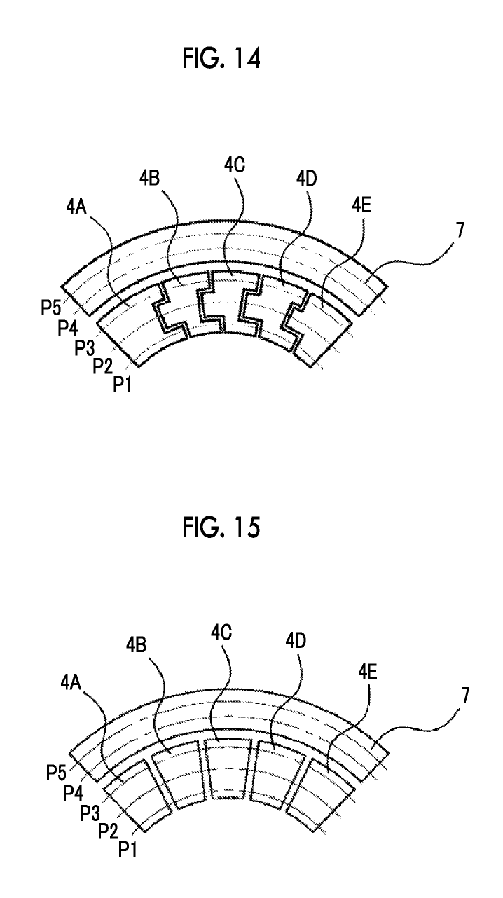

FIGS. 12 to 14 are diagrams showing examples of the shape of a gap in a case where the contact points 31 are aligned linearly. For example, as shown in FIGS. 12 and 13, the shape of a gap may be stepwise. In the case of rotating the sliding electrode 30 in the R direction (FIG. 7), the contact points 31A to 31C pass through the gaps in order of the contact points 31C, 31B, and 31A in the example shown in FIG. 12, and pass through the gaps in order of the contact points 31A, 31B, and 31C in the example shown in FIG. 13. The shape of each gap shown in FIG. 14 may be reversed in the horizontal direction with respect to that shown in FIG. 3 or the like, and the contact points 31A to 31C pass through the gaps in order of the contact points 31B, 31C, and 31A.

### Third Modification Example

In the operating device described above, the three contact points 31 may be aligned linearly in a predetermined direction (for example, in a direction perpendicular to the movement direction) with respect to the movement direction of each contact point 31. In contrast, in the third modification example, three gaps G1 to G3 may be formed between two edge portions facing each other in the two adjacent electrode patterns 4, and each of the two edge portions extends perpendicular to the movement direction of the contact point 31. That is, the three gaps G1 to G3 may be formed between two edge portions extending linearly.

FIG. 15 is a diagram showing a modification example of the electrode pattern 4 in which the gaps G1 to G3 are formed between two edge portions extending linearly. In the example shown in FIG. 15, the gaps G1 to G3 extend in the radial directions of the arc shaped trajectories P1 to P3. Accordingly, if the three contact points 31 are arranged in the same direction as above, the three contact points 31 are located in the gaps G1 to G3 at the same time. As a result, the sliding electrode 30 and the electrode pattern 4 are not electrically connected to each other. For this reason, the three contact points 31 may be arranged so that each of the other two or more contact points 31 is in contact with any one of the two adjacent electrode patterns 4 in a state in which any one contact point 31 is located between two edge portions.

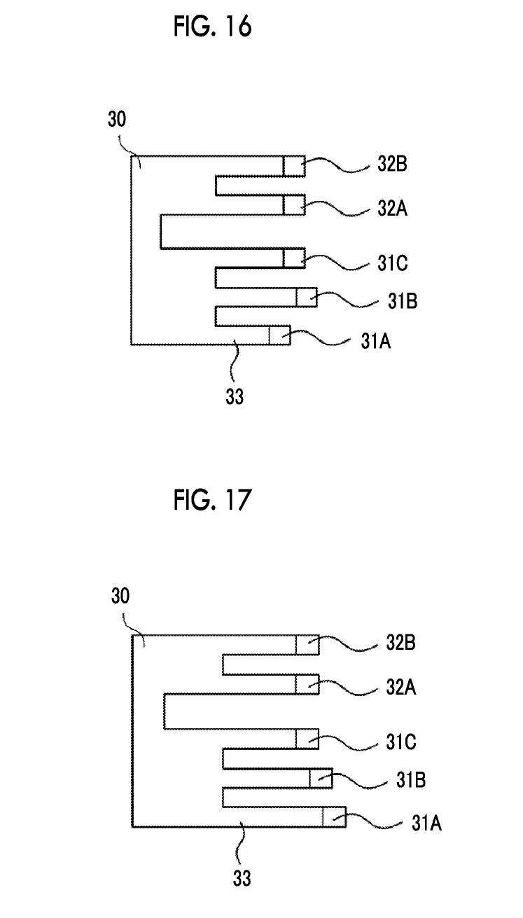

FIGS. 16 to 18 are diagrams showing examples of a sliding electrode applicable to the electrode pattern shown in FIG. 15.

In the example shown in FIG. 16, the contact point 31B may be provided on the tip of the arm portion 33 having the largest length from the base of the sliding electrode 30, the contact point 31C is provided on the tip of the next longest arm portion 33, and the contact point 31A is provided on the tip of the shortest arm portion 33. Therefore, the order of passing through the gap G in the case of rotating the sliding electrode 30 in the R direction (FIG. 7) from the one electrode pattern 4 to the adjacent electrode pattern 4 is the order of the contact points 31B, 31C, and 31A.

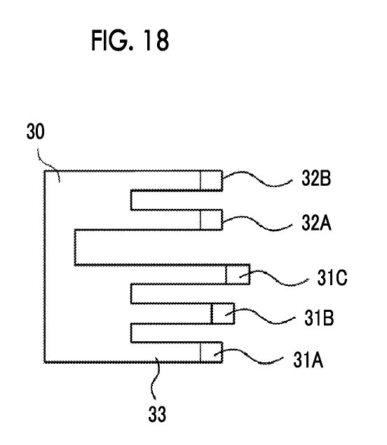

FIGS. 17 and 18 show the stepwise arrangement of the contact points 31A to 31C.

In the example shown in FIG. 17, the contact point 31A may be provided on the tip of the longest arm portion 33, the contact point 31B is provided on the tip of the next longest arm portion 33, and the contact point 31C is provided on the tip of the shortest arm portion 33. Therefore, the order of passing through the gap G in the case of rotating the sliding electrode 30 in the R direction (FIG. 7) is the order of the contact points 31A, 31B, and 31C.

In the example shown in FIG. 18, the contact point 31C may be provided on the tip of the longest arm portion 33, the contact point 31B is provided on the tip of the next longest arm portion 33, and the contact point 31A is provided on the tip of the shortest arm portion 33. Therefore, the order of passing through the gap G in the case of rotating the sliding electrode 30 in the R direction (FIG. 7) is the order of the contact points 31C, 31B, and 31A.

### Fourth Modification Example

In the embodiments described above, the operating member 2 rotates relative to the substrate 3, so that the contact points 31A to 31C move on the trajectories P1 to P5 that form concentric arcs. However, the relative displacement of the substrate 3 with respect to the operating member 2 is not limited to rotation. For example, the operating member 2 may move straight relative to the substrate 3. In this case, since the sliding electrode 3 moves straight with respect to the substrate 3, the trajectories P1 to P3 on which the contact points 31A to 31C move are parallel to each other.

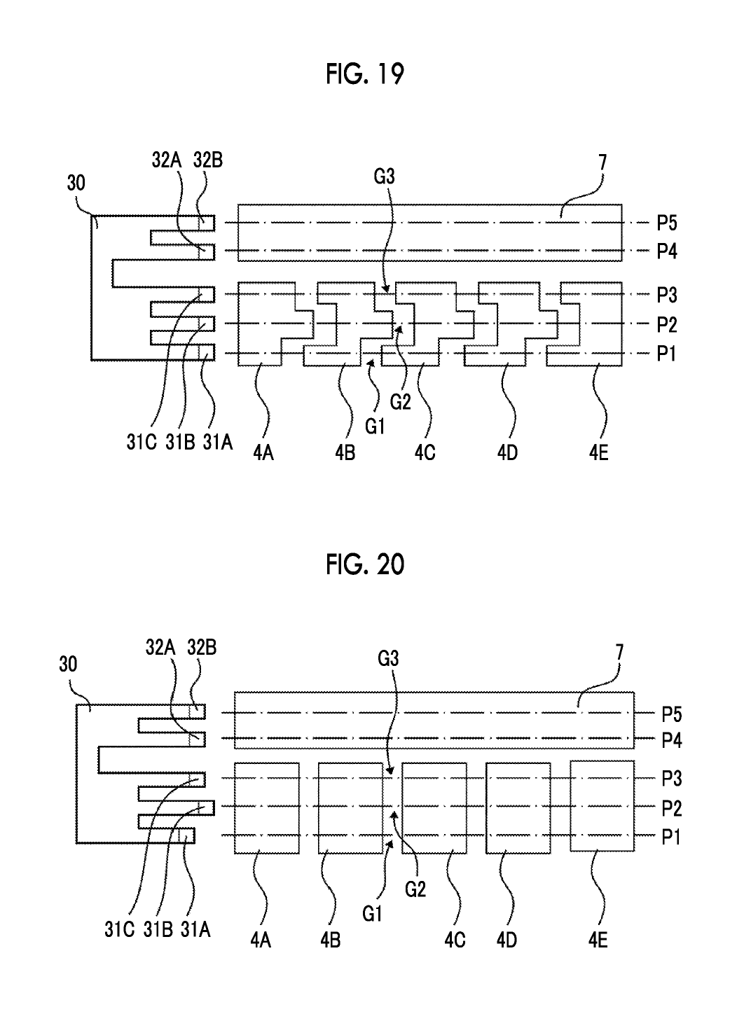

FIGS. 19 and 20 are first diagrams showing examples of the electrode pattern in a case where the contact points 31A to 31C of the sliding electrode 30 move on the parallel trajectories P1 to P4.

In the example shown in FIG. 19, the contact points 31A to 31C may be aligned linearly in a direction perpendicular to the movement direction. The location where each of the three gaps G1 to G3 located between the two adjacent electrode patterns 4 is disposed may be included in a region where the electrode pattern 4 is formed on two trajectories, on which the other two gaps are located, when viewed from a direction (vertical direction in FIG. 19) perpendicular to the movement direction of the contact points 31A to 31C. That is, a location where a gap is disposed on the one trajectory P may be included in a region where the gap G is not present on the other two trajectories P, when viewed from a direction perpendicular to the movement direction. For this reason, each of the other two contact points is in contact with any one of the electrode patterns 4A to 4E in a state in which any one of the three contact points 31A to 31C is located in one gap G. Therefore, in the same manner as in the embodiments described above, interruption of conduction due to contact failure of the contact point 31 of the sliding electrode 30 can be made to hardly occur.

The shape of a gap between electrode patterns in the example shown in FIG. 19 may be the same as a shape obtained by aligning the arrangements of the electrode patterns 4 in FIGS. 12 to 14 in a straight line, for example.

On the other hand, in the example shown in FIG. 20, the three gaps G1 to G3 are formed between two edge portions facing each other in the two adjacent electrode patterns 4, and each of the two edge portions extends perpendicular to the movement direction of the contact point 31. That is, the three gaps G1 to G3 may be formed between two edge portions extending linearly. The three contact points 31 are arranged so that each of the other two or more contact points 31 is in contact with any one of the two adjacent electrode patterns 4 in a state in which any one contact point 31 is located between two edge portions. For this reason, each of the other two contact points is in contact with any one of the electrode patterns 4A to 4E in a state in which any one of the three contact points 31A to 31C is located in one gap G. Therefore, in the same manner as in the embodiments described above, interruption of conduction due to contact failure of the contact point 31 of the sliding electrode 30 can be made to hardly occur.

The arrangement of the contact point 31 of the sliding electrode 30 in the example shown in FIG. 20 may be stepwise as shown in FIGS. 17 and 18.

Embodiments of the invention as described herein is not limited to the embodiments described above. That is, for the components of the embodiments described above, various changes, combinations, sub-combinations, and replacements can be made by those skilled in the art within the technical scope of the invention or within the range of its equivalents. Embodiments of the invention can be applied to combination switches, such as a turn signal for vehicles and a windshield wiper, or various electronic apparatuses.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. An operating device, comprising:
a substrate on which a plurality of electrode patterns are formed; and
a sliding electrode which has N contact points, where N is an integer of 3 or more, the N contact points sliding on the plurality of electrode patterns, which is held by an operating member that is displaced relative to the substrate according to an input operation, and whose state of connection with each of the plurality of electrode patterns at the N contact points is switched according to displacement of the operating member,
wherein N gaps located on N trajectories, on which the N contact points move according to the displacement of the operating member, are provided between two adjacent electrode patterns, and
in a state in which any one of the contact points is located in one of the gaps, each of the other two or more contact points is in contact with any one of the plurality of electrode patterns.

2. The operating device according to claim 1,
wherein the N contact points are aligned linearly in a predetermined direction with respect to a movement direction according to the displacement of the operating member, and
a location where each of the N gaps is disposed is included in a region where the electrode patterns are formed on two or more trajectories, on which the other gaps are located, when viewed from the predetermined direction.

3. The operating device according to claim 2,
wherein the predetermined direction is a direction perpendicular to a movement direction of each of the N contact points.

4. The operating device according to claim 1,
wherein the N gaps are formed between two edge portions facing each other in the two adjacent electrode patterns,
the two edge portions extend perpendicular to a movement direction of each of the N contact points, and
in a state in which any one of the N contact points is located between the two edge portions, each of the other two or more of the N contact points is in contact with any one of the two adjacent electrode patterns.

5. The operating device according to claim 1,
wherein, between the two adjacent electrode patterns, at least a first gap through which a first contact point passes, a second gap through which a second contact point passes, and a third gap through which a third contact point passes are provided on trajectories on which the N contact points move according to the displacement of the operating member, and
in a case where the first contact point, the second contact point, and the third contact point move from one of the two adjacent electrode patterns to the other electrode pattern, the second contact point reaches the second gap after the first contact point passes through the first gap, the third contact point reaches the third gap after the second contact point passes through the second gap, and the first and second contact points are in contact with the other electrode pattern when the third contact point passes through the third gap.

6. The operating device according to claim 1,
wherein the operating member rotates relative to the substrate according to the input operation, and
the N contact points move on N trajectories, which form concentric arcs, according to the rotation of the operating member.

7. The operating device according to claim 6,
wherein the N contact points are aligned in radial directions of the N trajectories that form the concentric arcs.

8. The operating device according to claim 7,
wherein edge portions of the two electrode patterns facing each other with the gap interposed therebetween are formed in parallel to a straight line, which passes through the gap and extends in the radial directions of the arc shaped trajectories.

9. The operating device according to claim 1,
wherein the operating member moves straight relative to the substrate according to the input operation, and
the N contact points move on the N trajectories parallel to each other according to the straight movement of the operating member.

10. The operating device according to claim 1,
wherein a common electrode pattern is further formed on the substrate,
the sliding electrode has at least one common contact point sliding on the common electrode pattern according to the displacement of the operating member, and
the common contact point is always in contact with the common electrode pattern while a state of connection with each of the plurality of electrode patterns at the N contact points is being switched according to the displacement of the operating member.

11. The operating device according to claim 10, further comprising:
a resistance circuit which has a plurality of electrode nodes, which are connected to the plurality of electrode patterns, and a measurement node and whose resistance value between the measurement node and the common electrode pattern changes when the state of connection with each of the plurality of electrode patterns at the N contact points is switched according to the displacement of the operating member; and
a signal generating circuit that generates a signal corresponding to a resistance value between the measurement node and the common electrode pattern.

12. The operating device according to claim 11, further comprising:
M (M is an integer of 2 or more) electrode patterns aligned along trajectories on which the contact points move,
wherein the resistance circuit includes a first resistor, which is provided between two adjacent electrode patterns of the M electrode patterns, and a second resistor provided between an electrode pattern, which is located at one end of the M electrode patterns, and the measurement node.
